(19) United States
(12) Patent Application Publication
(10) Pub. No.: US 2013/0021868 A1
(43) Pub. Date: Jan. 24, 2013

(54) Static Fluid Mixer and Method

(71) Applicants: Michael B. Doolin, Billings, MT (US); Barry M. Beringer, Billings, MT (US)

(72) Inventors: Michael B. Doolin, Billings, MT (US); Barry M. Beringer, Billings, MT (US)

(21) Appl. No.: 13/189,215

(22) Filed: Jul. 22, 2011

(51) Int. Cl. B01F 5/06; B01F 15/02

(52) U.S. Cl. 366/154.1; 366/340; 366/338; 366/339; 366/165.2; 366/174.1; 366/163.2

(57) ABSTRACT

A carrier fluid and an added input fluid are mixed together in a static mixer to create an emulsified output fluid mixture. The static mixer comprises a plurality of mixing chambers whose cross-sectional size expand considerably relative to an inlet, a series of bent and curved baffle plates which divert, rotate, divide, reverse and otherwise create turbulence in the combined flow, and inlet chamber in which the added input fluid is dispensed upstream into the carrier fluid, and a number of other structural mixing elements which, through turbulence, abrupt pressure drops and velocity changes, subdivide the added input mixture into very small volumetric quantities evenly dispersed within the carrier fluid to create a homogeneous output fluid mixture.

This invention relates to static mixing, and more particularly to a new and improved static mixer and method for continuously mixing, dispersing or emulsifying two or more different input fluid substances which are usually not soluble or chemically combinable with one another, to create a single highly-homogeneous output fluid mixture of the multiple fluid substances.

### BACKGROUND OF THE INVENTION

A static mixer is a device which does not require an external motor and mixing paddles or stirrers to mix or combine different substances. In most cases, the static mixer has no moving parts. Instead, the static mixer uses one or more stationary structural mixing elements which cause the fluid passing through the static mixer to experience abrupt variations in velocity and pressure. The variations in velocity and pressure create turbulence in the fluid. The turbulent fluid creates shear forces which disperse and distribute volumetric quantities of one of the input fluid substances, referred to herein as the added input fluid substance or added input fluid, within another one of the input fluid substances, referred to herein as the carrier fluid substance or the carrier fluid. The turbulence results principally from pressurized and energized interaction of the fluid with the structural mixing elements as the fluid is forced through the static mixer.

With sufficient induced turbulence, the added input fluid is dispersed evenly within the carrier fluid. The effectiveness of the mixing is therefore directly related to the ability of the structural mixing elements to induce sufficient turbulence to disperse the added fluid within the carrier fluid.

In addition to thoroughly dispersing the added input fluid within the carrier fluid, it is also desirable to subdivide and separate the added input fluid into very small volumetric quantities. The added input fluid may be powdered grains of solid material, a gas or a liquid. In the case of powdered grains of solid material as the added input fluid, the individual grains may adhere together in clumps, even when surrounded in the carrier fluid and subjected to turbulence. In the case of a gaseous added fluid, large bubbles of the added fluid may remain in the carrier fluid even when subjected to turbulence. In the case of a liquid added input fluid, the surface tension of that liquid may create large drops of the added input fluid, and those large drops may remain distributed in the carrier fluid even under the influence of turbulence.

Even though the clumps of powdered grains, or the large bubbles, or the large drops, may be uniformly mixed with the carrier fluid, the output mixture may still lack the desired level of homogeneity, because the clumps, bubbles and drops have not been subdivided into smaller parts. Under such circumstances, the static mixer lacks the capability to completely subdivide the added input fluid, although the larger clumps, bubbles and drops may be uniformly distributed within the output fluid.

An effective static mixer must therefore achieve not only an effective distribution of the added input fluid with the carrier fluid, but it must also effectively subdivide added input fluid into very small volumetric quantities, to achieve a highly homogeneous output fluid mixture.

Subdividing the added input fluid into very small volumetric quantities is particularly important when the added input fluid must be distributed over a large surface after it has been mixed with the carrier fluid. For example, in the case where the added input fluid is a particular chemical which is used to coat an object for some beneficial purpose, if the added input chemical has not been subdivided into very small volumetric quantities, the coating of the object will not be uniform because the clumps, large drops or large bubbles will create a non-uniform distribution when they interact with the object. Under such circumstances, a greater amount of the added input chemical will usually be required to coat the object adequately, due to the non-uniformity of the volumetric quantities of the added input fluid in the carrier fluid. This situation usually results in a higher cost of application, because more of the added input chemical is required than would otherwise be the case with a more thorough distribution of uniformly and finely subdivided volumetric quantities of the added input fluid in the carrier fluid. The effectiveness of the static mixer therefore directly affects the cost of use.

A typical use application of the static mixer is to pressurize the flow of carrier fluid with a pump before the carrier fluid is delivered to the static mixer, and thereafter use the pressurized output flow from the static mixer after the added input fluid has been mixed within the static mixer. Under such circumstances, there is usually a minimum pressure requirement in the output flow from the static mixer to accomplish the desired application. Because the static mixer consumes energy from the pressurized carrier fluid to obtain the energy for mixing the added fluid with the carrier fluid, pressure and energy is lost within the static mixer to achieve the mixing effect. It is desirable to minimize the amount of energy loss within the static mixer, without sacrificing the creation of sufficient turbulence to achieve thorough dispersal and subdivision of the added input fluid within the carrier fluid. Minimizing this energy loss reduces the cost of operation, by reducing the amount of energy consumed by the motors driving the pumps which supply the carrier fluid to the static mixer.

Another consideration relates to the physical size of the static mixer. Many applications for static mixers do not permit relatively large physical size devices to be used because of space constraints. Large static mixers can generally achieve more thorough mixing by adding more structural mixing elements, thereby increasing the overall physical size of the static mixer, and increasing the amount of energy consumed in achieving the level of mixing. The increased size and the number of structural mixing elements adds to the cost of the mixer, and may require the larger pumps and motors to supply more energy to the carrier fluid in order to achieve thorough mixing.

Inefficient static mixers which consume additional energy by creating high pressure drops cost more money to operate because the pumps which supply the carrier fluid must be larger and must use more energy to create sufficient pressure in the output fluid flow to achieve the purposes to which that output fluid flow is to be put. The pumps and related hardware must be constructed to withstand higher pressures and higher capacities, which add to the cost of the entire mixing system.

The effectiveness or efficiency of the static mixer is dependent upon the effectiveness of the structural mixing elements which create the abrupt variations in velocity and pressure to induce the turbulence. A greater degree of turbulence generally translates into a more thorough dispersal of the added input fluid in the carrier fluid, as well as more effective subdivision of the volumetric quantities of the added input fluid dispersed within the carrier fluid.

A variety of different configurations and types of structural mixing elements have been devised and employed in static mixers. Some types of structural mixing elements are better suited than other types of such elements for mixing different types and viscosities of added input fluids and carrier fluids. Some types of structural mixing elements are more effective in achieving different types and intensities of turbulence. Under such circumstances, a single type of static mixer may not achieve a universal and desired level of effectiveness in mixing a variety of different added input fluids and carrier fluids.

Furthermore, some configurations and types of structural mixing elements are more effective in creating a high level of turbulence without consuming an excessive amount of energy from the pressurized flow of the carrier fluid. Stated differently, the degree to which the fluids are uniformly mixed by the static mixer may not directly correlate to the amount of pressure drop or energy consumed by the mixer.

### SUMMARY OF THE INVENTION

The static mixer of this invention uses structural mixing elements which achieve both a uniform dispersal of the added input fluid within the carrier fluid, as well as an effective subdivision of the added input fluid into very small volumetric quantities which are uniformly dispersed within the carrier fluid, to achieve a very homogeneous output fluid mixture. The mixing is effective on a variety of different added input and carrier fluids, making the static mixer applicable to a larger variety of mixing applications. The static mixer achieves effective mixing by consuming a reduced amount of energy from the input carrier fluid, thereby creating a relatively lower pressure drop compared to other known types of static mixers which achieve a similar degree of homogeneity in the output fluid mixture. The type, organization and arrangement of the structural mixing elements results in a relatively compact sized static mixer which can be used in a variety of applications and which can be conveniently retrofitted into existing applications. The higher efficiency in mixing and the more homogeneous output fluid reduces use costs, because less energy is consumed in achieving the mixing and less of the typically-expensive added input fluid is required. The size and efficiency of the static mixer also reduces its cost of use because less equipment, such as pumps, are needed in conjunction with the static mixer. These same advantages and improvements are also achieved in the context of the methodology of this invention.

These benefits and improvements are achieved by a static mixing apparatus which mixes a carrier fluid and an added input fluid to create an output fluid mixture. An inlet portion of the static mixing apparatus comprises an inlet chamber which receives and combines together the carrier fluid and the added input fluid as a combined fluid. A main mixing portion of the static mixing apparatus is connected to the inlet portion to receive the combined fluid from the inlet chamber. The main mixing portion comprises a housing which defines an elongated cavity and a plurality of structural mixing elements positioned throughout the elongated cavity. The plurality of structural mixing elements disburse and subdivide volumetric quantities of the added input fluid within the carrier fluid due to interactive movement of the combined fluid with the structural mixing elements. An output portion of the static mixing apparatus is connected to the main mixing portion to receive the combined fluid from the terminal end of the elongated cavity after interacting with the structural mixing elements and to deliver the combined fluid as the output fluid mixture.

The structural mixing elements within the elongated cavity of the main mixing portion comprise first and second mixing chambers, each of which has an inlet passageway through which the combined fluid is received. The cross-sectional size of the inlet passageway to each mixing chamber is substantially smaller than the cross-sectional size of the mixing chamber having that inlet passageway. The substantially larger cross-sectional size of each mixing chamber has the effect of abruptly decreasing pressure and flow rate of the combined fluid entering the mixing chamber through the inlet passageway to induce turbulence in the combined fluid within the mixing chamber.

The structural mixing elements also comprise a plurality of baffle plates sequentially positioned within the elongated cavity. Each baffle plate includes a plurality of openings to pass the combined fluid through the baffle plates and a plurality of curved portions to deflect the combined fluid to induce turbulence. At least two of the baffle plates occupy relative rotationally offset relationships within the elongated cavity in which the openings and the curved portions cause the combined fluid to rotate within the elongated cavity when flowing downstream between the two baffle plates.

Additional features of the structural mixing elements and the static mixing apparatus include some or all of the following characteristics.

A flow reducer is positioned between the first and second mixing chambers to converge the combined fluid from the first mixing chamber into a tube having a substantially smaller cross-sectional size than the cross-sectional size of the first mixing chamber. The tube comprises the inlet passageway into the second mixing chamber, and the tube projects into the second mixing chamber to deliver the combined flow into the second mixing chamber at a position downstream of a location where the second mixing chamber commences, thereby inducing more turbulence in the combined fluid in the second mixing chamber. The second mixing chamber may be located upstream within the elongated cavity relative to the plurality of baffle plates.

Each of the plurality of baffle plates includes curved portions. The curved portions may be bent wing portions, with adjacent wing portions bent in opposite directions relative to one another to define the openings through the baffle plates and to divert the flow of combined fluid passing through the openings. The baffle plates may occupy relative rotationally offset relationships within the elongated cavity to rotate and divide the combined flow within the elongated cavity.

A support plate is positioned between and connected to a preceding upstream baffle plate and a subsequent downstream baffle plate. The support plate has at least one internal opening for conducting the combined fluid through the support plate. A seal extends between the support plate and the surface of the housing which defines the cavity to divert any combined fluid flowing along the surface of the housing through each internal opening of the support plate.

A first support structure extends between the preceding upstream baffle plate and the support plate and the flow reducer to establish the positions of the first mixing chamber, the flow reducer, the second mixing chamber, the preceding upstream baffle plate and the support plate, within the elongated cavity. A second support structure extends between each baffle plate and support plate to connect and orient the baffle plates and support plate within the cavity. The first and second support structures, the flow reducer, the plurality of baffle plates and the support plate comprise a unitary main mixing assembly. The main mixing assembly is insertable into and removable from the cavity as a unit. A ring is connected adjacent to the terminal end of the cavity to retain the main mixing assembly within the cavity.

The curved portions of the baffle plates may be formed as helical spirals. The helically spiraled baffle plates are connected together in a sequence in which each subsequent baffle plate is reversed in rotational direction compared to the rotational direction of the helical spiral of the preceding baffle plate. In addition, a leading edge of the subsequent helically spiraled baffle plate is oriented perpendicular to a trailing edge of the preceding helically spiraled baffle plate.

The inlet passageway to the first mixing chamber is an orifice extending from the inlet chamber into the first mixing chamber. Extending into the orifice is at least one vane which angles relative to an axis through the orifice to rotate the flow of combined fluid when passing through the orifice.

An injector within the inlet chamber injects the added input fluid in an upstream direction relative to the carrier fluid received in the inlet chamber. The inlet chamber has a cross-sectional size which is substantially larger than the cross-sectional size of an inlet conduit supplying the carrier fluid into the inlet chamber, to abruptly decrease the pressure and flow rate and thereby induce turbulence in the combined fluid within the inlet chamber. Alternatively the inlet portion comprises a body which defines a venturi through which the carrier fluid flows. The venturi creates a relative low pressure area within which the added fluid is delivered.

The invention also involves a method of mixing a carrier fluid and an added input fluid to create an emulsified output fluid mixture. The method involves conducting the carrier fluid and the added input fluid through a static mixing apparatus of the type previously described to create the emulsified output fluid mixture.

A more complete appreciation of the present invention and its scope may be obtained from the accompanying drawings, which are briefly summarized below, from the following detailed descriptions of presently preferred embodiments of the invention, and from the appended claims.

### BRIEF DESCRIPTION OF THE DRAWINGS

FIG. 1 is a perspective view of a static mixer which embodies the present invention.

FIG. 2 is a longitudinal cross-sectional view of the static mixer shown in FIG. 1.

FIG. 3 is a perspective view of a main mixing assembly 30 of the static mixer shown in FIGS. 1 and 2, with a portion of a flow reducer broken out.

FIG. 4 is a partial perspective and cross-sectional view of an input portion of the static mixer shown in FIGS. 1 and 2.

FIG. 5 is a partial elevational view of an orifice between the input portion and a main mixing portion of the static mixer shown in FIG. 2, taken substantially in the plane of line 5-5 in FIG. 2.

FIG. 6 is a perspective view of a winged baffle plate of the main mixing portion of the static mixer shown in FIGS. 2 and 3.

FIG. 7 is a perspective and longitudinal cross-sectional view of an alternative to an input portion of the static mixer shown in FIGS. 2 and 4.

FIG. 8 is a perspective and longitudinal cross-sectional view of another alternative to the input portions shown in FIGS. 2, 4 and 7.

FIG. 9 is a perspective view of three series-connected half-flight spiral helix baffle plates which may be linked in a similar manner form an alternative to the series of winged baffle plates and support plates of the main mixing assembly shown in FIGS. 2 and 3.

### DETAILED DESCRIPTION

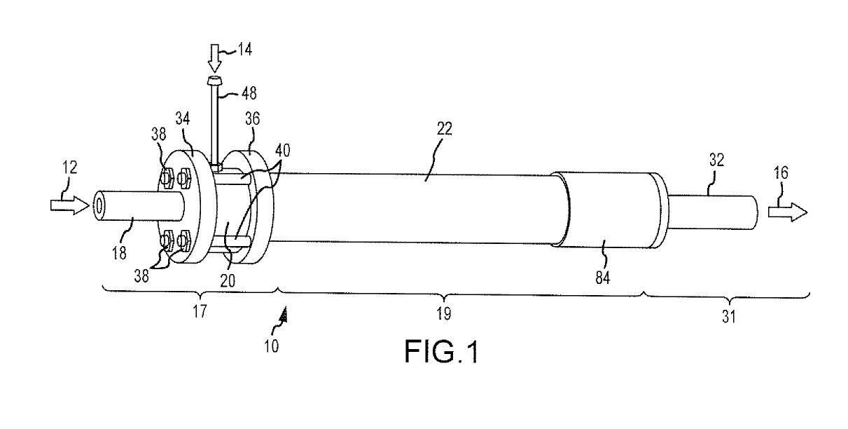

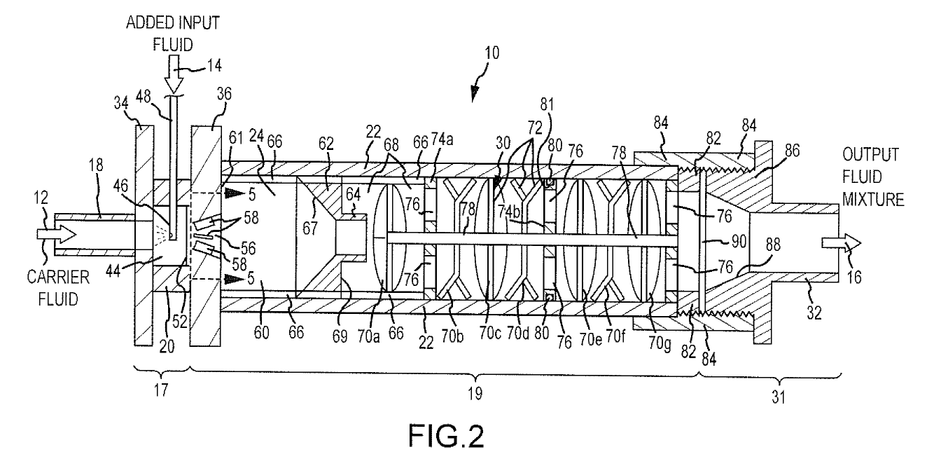

A static mixer 10 which embodies the present invention is shown in FIGS. 1 and 2. The static mixer 10 mixes an input carrier fluid 12 with a relatively smaller amount of an added input fluid 14 to achieve an output fluid mixture 16 which is a substantially homogeneous dispersal of very finely subdivided volumetric quantities (powder grains, drops or bubbles) of the added input fluid 14 dispersed throughout the carrier fluid 12. The static mixer 10 is a continuous flow type mixer in which the carrier fluid 12 and the added input fluid 14 are continuously supplied to static mixer 10 to create the output fluid mixture 16. Typically, the carrier fluid 12 will have a much higher volumetric flow rate than the added input fluid 14, although the static mixer 10 will also accommodate comparable volumetric flows of the carrier fluid 12 and the added input fluid 14. The carrier fluid 12 and the added input fluid 14 are pressurized by pumps (not shown) before delivery into the static mixer 10. In many cases, the output fluid mixture 16 is delivered with enough pressure for particular applications, such as spraying or coating.

The static mixer 10 includes an input portion 17 in which the carrier fluid 12 and the added input fluid 14 are received and in which some mixing occurs. An inlet conduit 18 receives the carrier fluid 12 and supplies the carrier fluid 12 to an injector body 20. The injector body 20 receives the added input fluid 14 supplied to the mixer 10. The added input fluid 14 is initially dispersed within the carrier fluid 12 within the injector body 20 and the combined fluid is then conducted into the other portions of the static mixer 10.

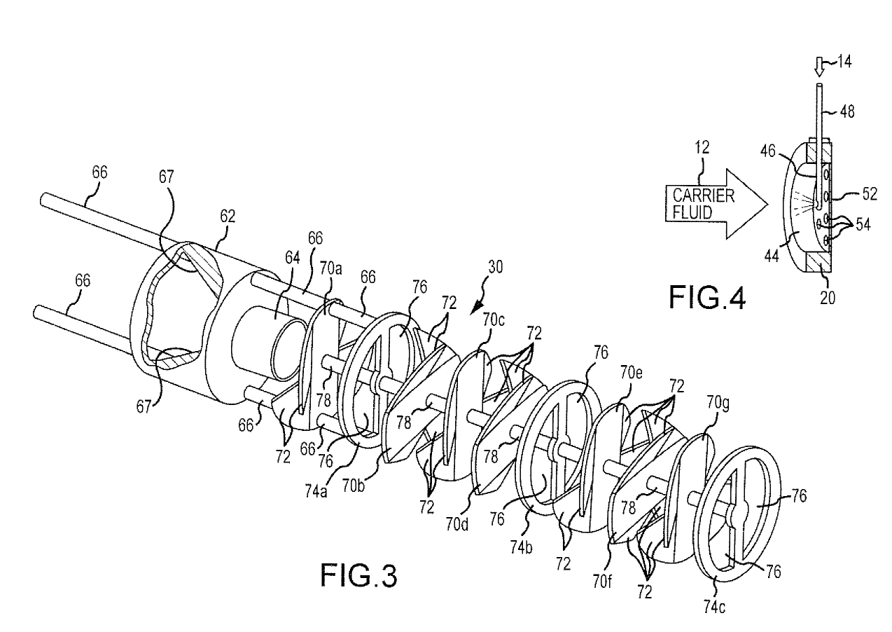

The static mixer 10 also includes a main mixing portion 19 which receives the combined fluid from the input portion 17 and in which the majority of the mixing between the carrier fluid 12 in the added input fluid 14 is achieved. The main mixing portion 19 includes a cylindrical housing 22 which defines a cylindrical interior cavity 24 within which a main mixing assembly 30 (FIGS. 2 and 3) creates and achieves the majority of the mixing within the mixer 10. The main mixing assembly 30 includes and defines a plurality of structural mixing elements which interact with the flow of combined fluid to mix the carrier and added input fluids 12 and 14 as they pass through the cavity 24. The main mixing effect is achieved by a combination of abrupt pressure and flow rate changes and flow deflection and division, all of which creates turbulence.

The static mixer 10 also includes an output portion 31 which receives the combined fluid from the main mixing portion 19 and which delivers the output fluid mixture 16 from the static mixer after a slight amount of additional mixing occurs within the output portion 31. An outlet conduit 32 of the output portion 31 conducts the mixed output fluid 16 from the static mixer 10.

The injector body 20 of the input portion 17 is connected between a flange 34 which extends radially outward from a downstream end of the inlet conduit 18 and a flange 36 which extends radially outward from an upstream end of the housing 22. The flanges 34 and 36 are integrally and sealingly connected to the inlet conduit 18 and the housing 22, respectively, such as by welding. The injector body 20 is held between the flanges 34 and 36 by nuts 38 screwed onto studs 40 which extend forward from the flange 36 of the housing 22. Conventional spiral wound pipe flange gaskets (not shown) are positioned between both sides of the injector body 20 and the flanges 34 and 36 to seal the injector body 20 to the flanges 34 and 36 when the nuts 38 are tightened.

The injector body 20 defines an internal inlet chamber 44 in which at least one injection nozzle 46 is located, as shown in FIGS. 2 and 4. The injection nozzle 46 is attached to an end of a pipe 48 which extends through the injector body 20 and into the inlet chamber 44. The injection nozzle 46 may be formed by one or more very small diameter holes formed in a closed end of the pipe 48, or by a conventional injection nozzle head (not shown) connected to an open end of the pipe 48. The added input fluid 14 is supplied through the closed pipe 48, and the injection nozzle 46 sprays the added input fluid 14 upstream into the carrier fluid 12 within the inlet chamber 44. The upstream spray of the added input fluid 14 into the carrier fluid 12 assists in initially distributing the added input fluid into the carrier fluid, as compared to injecting the added input fluid downstream which would tend to cause a mostly non-distributed flow stream of added input fluid surrounded by the larger flow of carrier fluid.

The added input fluid 14 is introduced into the inlet chamber 44 at a higher pressure than the pressure of the carrier fluid 12 within the inlet chamber 44, to prevent the carrier fluid 12 from flowing into the injection nozzle 46. More than one injection nozzle 46 could be used, to deliver more of the added input fluid into the carrier fluid 14 within the inlet chamber 44, and/or to inject multiple added input fluids into the carrier fluid.

The relative proportion of carrier fluid 12 and the added input fluid 14 in the output fluid 16 is achieved by varying the pressure at which the carrier fluid 12 is supplied to the inlet chamber 44 relative to the pressure at which the carrier fluid is delivered through the input conduit 18. Of course, the size of the input conduit 18 and the size and number of injection nozzles 46 can also be adjusted to vary the relative proportion of carrier fluid 12 to added input fluid 14 in the output fluid mixture 16.

The inlet chamber 44 in the injector body 20 is larger in diameter and volumetric size than the inside diameter and volumetric size of the inlet conduit 18. As a result, the transition from the smaller inlet conduit 18 to the larger inlet chamber 44 causes an abrupt pressure drop and decrease in flow rate of the carrier fluid 12 within the inlet chamber 44, both of which induce turbulence in the combined fluid in the inlet chamber 44. The turbulence of the carrier fluid 12 in the inlet chamber 44 further assists in dispersing the upstream-injected added input fluid 14 into the carrier fluid 12 within the inlet chamber 44.

A perforated plate 52 extends across a rear portion of the inlet chamber 44, as shown in FIGS. 2 and 4. Holes 54 in the perforated plate 52 introduce a slight amount of flow disturbance or turbulence, caused by abrupt pressure and velocity changes as the fluid passes through the holes 54. The resulting induced turbulence achieves some mixing within the inlet chamber 44 both in front of the holes 54 in the perforated plate 52 and after the fluid flows out of the holes 54 in the perforated plate 52.

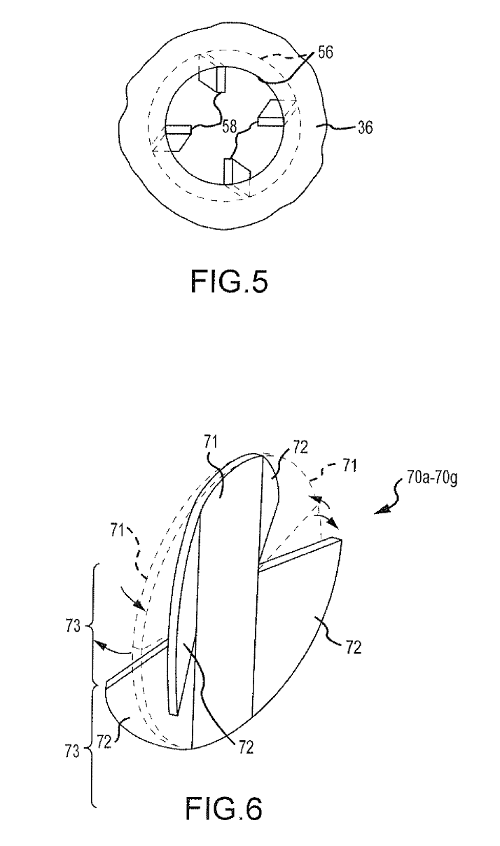

The fluid from the inlet chamber 44 enters the main mixing portion 19 through an orifice 56 formed in the flange 36, as shown in FIGS. 2 and 5. The orifice 56 has a diameter, or cross-section size which is less than the diameter or size of the inlet chamber 44 and the cumulative size of the holes 54 in the perforated plate. The reduced diameter of the orifice 56 causes an abrupt increase in pressure and flow rate of the combined fluid entering the orifice 56.

The orifice 56 has a plurality of radially extending and axially angled vanes 58 which extend inward into the flow through the orifice 56, as shown in FIGS. 2 and 5. The angled orientation of the vanes 58 relative to an axis through the orifice 56 create mechanical rotation of the fluid passing through the orifice 56. The mechanical rotation of the fluid passing through the orifice 56 creates flow disturbances which further aid mixing. Furthermore, the orifice 56 is preferably tapered to expand radially outward in the downstream direction, as shown in FIG. 2. A radial expansion causes the flow rate of the combined fluid to decrease slightly as it passes through the orifice 56. The decreased flow rate and the mechanical rotation induced by the vanes 58 combine to create turbulence through the orifice 56 to further contribute to mixing.

The fluid exiting the orifice 56 enters a relatively large mixing chamber 60 defined by the substantially larger diameter of the cavity 24 of the housing 22. The transition from the orifice 56 to the mixing chamber 60 is abrupt and substantial, which creates an abrupt and substantial pressure drop and an abrupt and substantial reduction in the flow rate, both of which induce turbulence and shear within the fluid in the mixing chamber 60. The turbulence substantially contributes to further mixing. Even though the orifice 56 is slightly tapered, the transition between the orifice 56 and the radially extending downstream wall 61 of the flange 36 has the effect of creating slight vortices or eddy currents that expand outward from the outer edges of the orifice 56 within the fluid in the mixing chamber 60. These vortices create turbulence and shear within the fluid in the mixing chamber 60 to contribute to mixing.

The downstream end of the mixing chamber 60 is closed by a flow reducer 62 from which a small tube 64 extends downstream, as shown in FIGS. 2 and 3. A pair of rods 66 are attached to the flow reducer 62 at diametrically opposite edge positions at the outer periphery of the flow reducer 62. The rods 66 extend along an inner surface of the housing 22 within the cavity 24 in an upstream direction within the mixing chamber 60. The upstream end of the rods 66 contact the wall 61 of the flange 36 within the mixing chamber 60. The rods 66 space the reducer 62 from the flange 36 and thereby establish the longitudinal dimension of the mixing chamber 60 between the flow reducer 62 and the downstream wall 61 of the flange 36.

An upstream surface 67 of the flow reducer 62 is generally funnel or frustoconical shaped. The frustoconically shaped surface 67 tapers or converges inward in the downstream direction to force the fluid in the relatively larger diameter mixing chamber 60 into the relatively smaller diameter tube 64. As the fluid flows along the frustoconically shaped surface 67, its pressure increases and its flow rate increases, thereby creating turbulence and shear effects which further contribute to mixing. The transition from the frustoconically shaped surface 67 into the tube 64 also creates turbulent flow which further contributes to mixing.

The tube 64 projects downstream into a second mixing chamber 68, relative to a downstream radially extending wall 69 of the flow reducer 62. The mixing chamber 68 is defined by the substantially larger diameter of cavity 24 of the housing 22. The transition from the tube 64 to the mixing chamber 60 is abrupt and substantial, which creates an abrupt and substantial pressure drop and an abrupt and substantial reduction in the flow rate, both of which induce considerable turbulence and shear in the fluid within the mixing chamber 68. The turbulence and shear substantially contributes to further mixing.

In addition, the extension of the tube 64 into a downstream position into the mixing chamber 68 creates vortices and eddy currents which expand radially outward and possibly even upstream from the downstream end of the tube 64 within the mixing chamber 68. These vortices and eddy currents create substantial turbulence and shear effects within the fluid in the mixing chamber 68, and they contribute significantly to the amount of mixing achieved. These vortices and eddy currents exist principally because of the substantial difference in flow rate of the fluid exiting the tube 64 and the considerably slower moving volume of the fluid elsewhere within the mixing chamber 68.

A first upstream baffle plate 70a interacts with the turbulent flow of the combined fluid leaving the mixing chamber 68. The baffle plate 70a, as shown in FIG. 6, as formed by a solid disk 71 which has been cut diametrically on opposite sides almost to its center, to form two half sectors 73. Diametrically opposite end portions 72 of each half sector 73 are bent in respectively opposite directions. Furthermore, the end portions 72 of the adjoining half sector 73 are bent in respectively opposite directions. The bent portions 72 function as flow deflectors and are referred to as wing portions.

The bent wing portions 72 provide spaces for the flow through the baffle plate 70a. The bent wing portions 72 also act as vanes to induce an upstream, downstream and radial movement of the fluid passing through the spaces between the bent wing portions 72. The upstream, downstream and radial movement of the fluid passing through the spaces between the bent wing portions 72 is complex in its flow pattern, and that complex flow pattern creates multiple instances or zones of fluid shear and turbulence which contributes substantially to further subdividing the volumetric quantities of the added input fluid within the carrier fluid, as well as substantially dispersing the small volumetric quantities of the added input fluid within the carrier fluid.

The baffle plate 70a is substantially identical to multiple other winged baffle plates 70b-70g which are spaced in the sequence along the cavity 24 of the housing 22, downstream of the first upstream baffle plate 70a. In each subsequent downstream baffle plate, the space provided between the adjacent bent wing portions 72 is rotated 90° relative to the preceding and subsequent baffle plates, as shown in FIG. 3. With the spaces between the bent wing portions 72 rotated in this manner, the fluid flows between the baffle plates with a reversing rotational movement while being divided. This rotational and dividing fluid movement induces further complexity into the pattern of flow diversions which contributes significantly to the dispersal of the volumetric quantities of the added input fluid 14 within the carrier fluid 12.

The rods 66 also extend downstream from the flow reducer 62 and connect to the edge of the winged baffle plate 70a at diametrically opposite positions, and also connect to an upstream circular support plate 74a at diametrically opposite positions. The rods 66, which extend along the edges of the flow reducer 62 to the upstream baffle plate 70a and the upstream support plate 74a, hold the first baffle plate 70a and the circular support plate 74a in position relative to the flow reducer 62, as well as in a fixed relationship within the cavity 24.

The upstream circular support plate 74a has substantial openings 76 formed therethrough, as shown in FIG. 3. The openings 76 allow the fluid to pass through the support plate 74a. Although the openings 76 are substantial in size, they nevertheless create a slight restriction to the flow of the fluid mixture 16, which slightly changes the pressure and flow velocity as the fluid moves through the openings 76, which further contributes to the complex pattern of the turbulent flow and the mixing.

The upstream support plate 74a is substantially identical to middle and downstream circular support plates 74b and 74c, respectively. A center rod 78 connects at the axial center of the upstream winged baffle plate 70a and extends downstream through the center of the upstream circular support plate 74a. The center rod 78 continues downstream from the upstream support plate 74a to connect to the axial center of the winged baffle plates 70b, 70c and 70d, and then to connect to the axial center of the middle circular support plate 74b. From the middle circular support plate 74b, the center rod 78 continues downstream to connect to the axial centers of the winged baffle plates 70e, 70f and 70g, and then the center rod 78 terminates at a connection to the axial center of the downstream circular support plate 74c. The edge connection of the rods 66 to the winged baffle plate 70a and the circular support plate 74a, and the connection of the center rod 78 between the baffle plates 70a-70g and the support plates 74a-74c, hold together the entire assembly of baffle plates 70a-70g, the support plates 74a-74c, and the reducer 62, thereby forming the main mixing assembly 30.

An O-ring 80 is located in an annular groove 81 in the outer periphery of the center support plate 74b. The O-ring 80 is slightly compressed between the groove 81 and the inner surface of the cavity 24 of the housing 22. The slightly compressed O-ring 80 forms a seal and has the effect of diverting any thin stream of laminar combined fluid flowing along the inner surface of the cavity 24 through the openings 76 in the center support plate 74b. Any thin stream of laminar fluid flow which may attempt to move along the inner surface of the cavity 24 in the small clearance between the radially outside edges of the winged baffle plates 70a-70d and the upstream support plate 74a is terminated and forced into the main flow by the effect of the O-ring 80. Preventing the laminar surface flow along the inner surface of the cavity 24 in this manner helps ensure that all of the fluid flowing through the cavity 24 is mixed by the abrupt pressure drops and velocity changes and flow deflections which induce the turbulence and shear forces that cause effective mixing.

The main mixing assembly 30 is inserted into the cavity 24 at the downstream end of the housing 22. The main mixing assembly 30 is secured within the cavity 24 by a threaded retention ring 82 which screws into internal threads of a coupling 84 which is hermetically attached to the downstream end of the housing 22, preferably by welding. The ring 82 abuts against the downstream support plate 74c, forcing the the upstream end of the rods 66 to abut against the downstream wall 61 of the flange 36. In this manner, the ring 82 fixes the position of the main mixing assembly 30 within the cavity 24 and thereby establishes the size, orientation and configuration of the turbulence-inducing components of the main mixing assembly 30. As an alternative to the threaded retention ring 82, a snap ring may be expanded into an internal groove (neither shown) to hold the main mixing assembly 30 in the cavity 24.

A flow reducer 86 of the output portion 31 of the static mixer 10 is also threaded into the internal threads of the coupling 84, as shown in FIG. 2. An inside surface 88 of the flow reducer 86 is frustoconically shaped or tapered to converge in the downstream direction from the inside diameter of the retention ring 82 to the inside diameter of the outlet conduit 32. The outlet conduit 32 is preferably integrally formed as a portion of the reducer 86, or alternatively may be formed as a separate conduit which is inserted into and fixed to the flow reducer 86. The frustoconically shaped tapered surface 88 increases the speed of the fluid as it exits the cavity 24 of the main mixing portion 19 as the output fluid mixture 16 exits the static mixer 10 through the outlet conduit 32. The frustoconically shaped tapered surface 67 thereby creates slight additional shear forces which assist in further mixing.

A perforated plate 90 is held in position between the downstream end of the retention ring 82 (or the alternative snap ring) and the upstream end of the flow reducer 86. The perforated plate 90 is similar in configuration to the perforated plate 52 (FIG. 4). The fluid flow through holes (not shown) in the perforated plate 90 creates pressure and velocity changes in the fluid, which induces turbulence as the flow moves through the perforated plate 90 into the area defined by the frustoconically shaped surface 88, before the flow moves into the outlet conduit 32.

Some of the specific components of the static mixer 10 described above may be replaced by alternatives to those components. The alternatives may prove beneficial for mixing different types of carrier fluids 12 with different types of added input fluids 14.

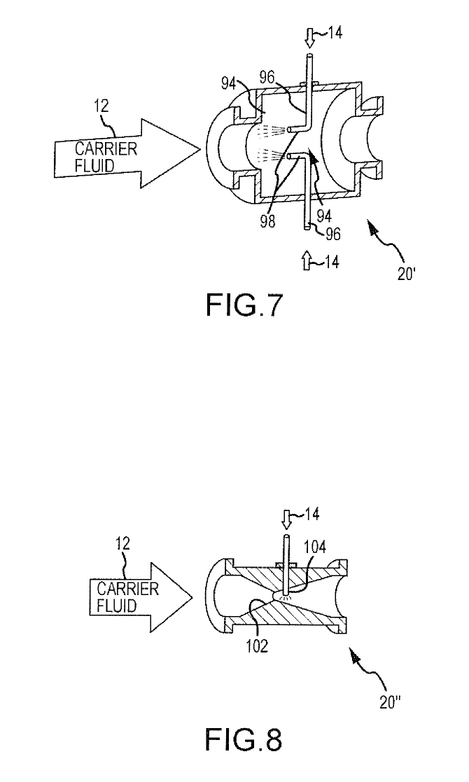

One alternative 20′ of the injector body 20 (FIGS. 2 and 4) is shown in FIG. 7. The injector body 20′ has a high volume intellect chamber 94 that accommodates a relatively greater volumetric quantity of the carrier fluid 12. One or more relatively larger injection nozzles 96 extend into the inlet chamber 94. Each injection nozzle 96 is formed as a small conduit which has been bent to extend an axial portion 98 forward or upstream into the fluid flow through the chamber 94. The axial portion 98 of the injection nozzle 96 terminates either an open end or in a spray nozzle head (not shown). A larger amount of flow of the added input fluid 14 can be accommodated, or due to the larger volume of the chamber 94, a longer dwell time for mixing the added input fluid 14 to the carrier fluid 12 is achieved.

If a single injection nozzle 96 is used, its axial portion 98 will usually be located approximately at the transverse center of the chamber 94. If multiple injection nozzles 96 are employed, the axial portions 98 of those nozzles 96 are usually distributed at uniform relative positions within in the chamber 94 to disperse the added input fluid 14 uniformly within in the chamber 94. Because of the larger volume of the chamber 94, there is a greater pressure drop and velocity decrease within the chamber 94, compared to the smaller chamber 44 of the injector body 20 (FIGS. 2 and 4), thereby securing greater turbulence and shear flow within the injector body 20′.

A second alternative 20″ of the injector body 20 (FIGS. 2 and 4) is shown in FIG. 8. The injector body 20″ is formed as an internal venturi 102. The inlet of the venturi 102 is the same as the inside diameter of the inlet conduit 18, and the outlet diameter of the venturi 102 is the same diameter as the inlet diameter of the orifice 56. The flow of fluid through the venturi 102 creates a low pressure area in a neck area of the venturi 102. A nozzle 104 is oriented to open perpendicularly to the reduced pressure fluid flow through the neck of the venturi 102, to take maximum advantage of the low pressure created by the increased velocity of the carrier fluid through the reduced diameter or neck portion of the venturi 102. The low pressure in the neck of the venturi 102 helps draw the added input fluid 14 into the carrier fluid 12. The injector body 20″ is useful in adding viscous input fluid 14 to the carrier fluid 12.

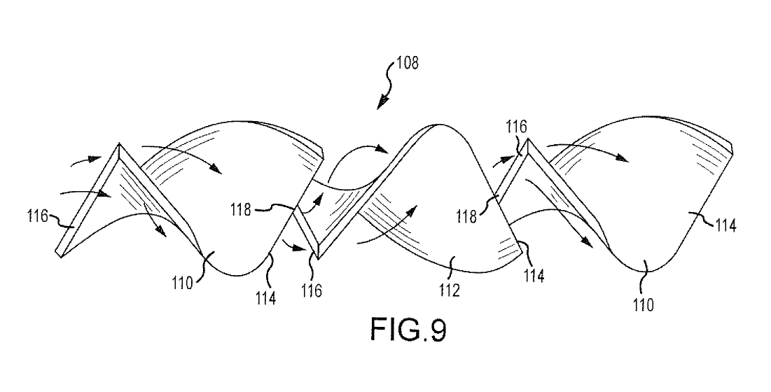

An alternative to the winged baffle plates 70a-70g and the support plates 74a-74c is a reversing, helically-spiraled baffle plate assembly 108, shown in FIG. 9. The helically spiraled baffle plate assembly 108 is formed by a series of connected-together, helically twisted baffle plates 110 and 112. In the in the example of the reversing, helically-spiraled baffle plate assembly 108 shown in FIG. 9, three helical baffle plates 110 and 112 form the assembly 108. In actuality, many more baffle plates 110 and 112 will typically be used in forming the assembly 108.

Each baffle plate 110 and 112 has been twisted in a helically spiraled manner through one half of a complete revolution. As such, a rearward or trailing edge 114 of each helical baffle plate 110 and 112 has been rotated 180° relative to a forward or leading edge 116 of that same helical baffle plate. Each helical baffle plate 110 and 112 therefore assumes a 180° spiral helix configuration.

The direction of the helical spiral of each subsequent helical baffle plate in the assembly 108 is reversed relative to its preceding and its subsequent helical baffle plates. In the assembly 108 shown in FIG. 9, the direction of the helical spiral of the first and third (as shown) helical baffle plates 110 is clockwise (as shown) and reversed from the counterclockwise (as shown) direction of the helical spiral of the next sequential helical baffle plate 112. Arranged in this manner, each sequential helical baffle plate 110 and 112 rotates the fluid flowing over it in the opposite direction compared to the rotational direction of the preceding and following helical baffle plates.

The trailing edge 114 of the leading helical baffle plate is connected at 118 to the leading edge 116 of the next subsequent or downstream helical baffle plate. The connection 118 occurs at the transverse centers of the trailing and leading edges 114 and 116, preferably by welding the helical baffle plates together at the center locations 118.

Furthermore, the connection of the adjoining helical baffles plates at the trailing and leading edges 114 and 116 establishes the trailing edge 114 of the upstream helical baffle plate in a generally perpendicular position relative to the leading edge 116 of the downstream helical baffle plate. Arranged in this manner, the fluid flow delivered from one side of the preceding helical baffle plate is divided into two parts by the subsequent helical baffle plate. One part of the divided-out fluid flow from one side of the preceding helical baffle plate is combined with one part of the fluid flow from the other side of the preceding baffle plate. Each subsequent helical baffle plate divides and combines the flow parts in this manner on a continuous basis. Such continual division and recombination achieves uniform dispersion.

A complex pattern of pressure changes and velocity changes accompanies these flow rotations, flow reversals, flow divisions and flow recombinations. This complex pattern of flow deflections induces turbulence and shear effects within the fluid flow to promote thorough and homogeneous mixing as the flow moves through the connected series of helically twisted baffle plates 110 and 112 of the assembly 108.

The static mixer 10 achieves improved mixing or dispersion by use of multiple different types and configurations of structural mixing elements. The structural mixing elements achieve both a uniform dispersal of the added input fluid within the carrier fluid and also effectively subdivide the added input fluid into very small volumetric quantities which are then uniformly dispersed within the carrier fluid, to achieve a very homogeneous output fluid mixture.

As an Example of the effectiveness of the static mixer, a mixer having the configuration shown in FIGS. 1 and 2 was used to create an emulsion of approximately 1 quart of conventional 30 weight motor oil with approximately 100 gallons of water. The entire 100 gallons of water was pumped through the static mixer in approximately 2 minutes. The entire quart of motor oil was added in a single pass of the 100 gallons of water passed through the static mixer, to form a water-oil emulsion. The water and the motor oil distributed in it were delivered into a tank, and the degree of natural separation of the oil and water was observed visually over time. The quality or degree of emulsification of the water and oil was judged by the amount of time required for the oil and water to separate out of the emulsion and recombine. A minute observable separation of the oil and water occurred after about 24 hours, and after approximately 72 hours, a significant amount of oil still remained suspended in emulsion. These observations were judged to indicate a very high quality and degree of emulsification of the oil in the water.

The relatively long amount of time during which the oil remained dispersed and emulsified within the water indicates a high degree of mixing and a high degree of subdivision of the volumetric quantities of oil into much smaller volumetric quantities that were evenly dispersed within the mixture. A lesser degree of dispersion and subdivision would have resulted in a considerably shorter amount of time to observe the separation.

In addition to the beneficial improvement of more thorough mixing and subdivision of the added inlet fluid, the more thorough mixing and dispersion is achieved, while still preserving enough input energy to allow the output fluid mixture 16 to be used in many industrial applications without additionally pumping it, such as spraying or coating. To illustrate this aspect, in the Example of creating the emulsion of water and oil, described above, the pressure of the input water supplied to the static mixer was approximately 58 pounds per square inch, and the pressure of the output fluid mixture of the emulsified water and oil leaving the mixture was approximately 16 pounds per square inch. The 16 pound per square inch outlet pressure is sufficient to apply the output fluid mixture for many industrial applications, without additionally raising its pressure by subjecting it to further pumping.

The type, organization and arrangement of the structural mixing elements results in a relatively compact sized static mixer which can be used in a variety of new and retrofit applications. In the Example described above of mixing oil with water, the mixer is approximately 28 inches long between the inlet conduit and the outlet conduit. The mixer weighs approximately 24 pounds when made from steel. The outside diameter of the housing 22 is less than 5 inches. The static mixer is compact enough to be easily portable to onsite locations at which fluids are desired to be mixed immediately prior to use of the mixed fluids.

The static mixer is easily manufactured and assembled due to the modular nature of the main mixing assembly 30, and the ability to insert and withdraw that main mixing assembly from within the cavity 24 of the housing 22 by the removable retention ring 82 and output flow reducer 86. Consequently, it is relatively easy to assemble and replace any of the components of the main mixing assembly 30, if necessary or desirable. The static mixer 10 is also relatively inexpensive to construct and operate compared to similar known static mixing devices.

Many other advantages and improvements will become apparent upon fully appreciating the significant aspects of the present invention. Presently preferred embodiments of the present invention and its many improvements have been described with a degree of particularity. This description is of preferred examples of implementing the invention, and is not necessarily intended to limit the scope of the invention. The scope of the invention is defined by the scope of the following claims.

What is claimed is:

1. A static mixing apparatus for mixing a carrier fluid and an added input fluid to create an output fluid mixture, comprising:
an inlet portion comprising an inlet chamber which receives and combines together the carrier fluid and the added input fluid as a combined fluid;
a main mixing portion connected to the inlet portion to receive the combined fluid from the inlet chamber, the main mixing portion comprising a housing defining an elongated cavity and a plurality of structural mixing elements positioned throughout the elongated cavity, the plurality of structural mixing elements disbursing and subdividing volumetric quantities of the added input fluid within the carrier fluid from interactive movement of the combined fluid with the structural mixing elements from an upstream position adjacent to the inlet portion to a downstream position adjacent to a terminal end of the elongated cavity; and
an output portion connected to the main mixing portion to receive the combined fluid from the terminal end of the elongated cavity after interacting with the structural mixing elements and to deliver the combined fluid as the output fluid mixture; wherein:
the plurality of structural mixing elements within the elongated cavity of the main mixing portion comprise:
first and second mixing chambers each of which has an inlet passageway through which the combined fluid is received, each mixing chamber having a cross-sectional size and each inlet passageway having a cross-sectional size, the cross-sectional size of the inlet passageway to each mixing chamber being substantially smaller than the cross-sectional size of the mixing chamber having that inlet passageway, the substantially larger cross-sectional size of each mixing chamber abruptly decreasing pressure and flow rate of the combined fluid entering the mixing chamber through the inlet passageway to induce turbulence in the combined fluid within the mixing chamber; and
a plurality of baffle plates sequentially positioned within the elongated cavity, each baffle plate including a plurality of openings to pass the combined fluid through the baffle plates and a plurality of curved portions to deflect the combined fluid to induce turbulence in the combined fluid flowing through the openings, at least two of the plurality of baffle plates occupy relative rotationally offset relationships within the elongated cavity in which the openings and the curved portions cause the combined fluid to rotate within the elongated cavity upon flowing downstream between the two baffle plates.

2. A static mixing apparatus as defined in claim 1, wherein the plurality of structural mixing elements further comprise:
a flow reducer positioned between the first and second mixing chambers to converge the combined fluid from the first mixing chamber into a tube having a substantially smaller cross-sectional size than the cross-sectional size of the first mixing chamber; and wherein:
the tube comprises the inlet passageway into the second mixing chamber;
the tube projects into the second mixing chamber to deliver the combined flow into the second mixing chamber at a position downstream of a location where the second mixing chamber commences, the projection of the tube into the second mixing chamber also inducing vortices in the combined fluid delivered into the second mixing chamber.

3. A static mixing apparatus as defined in claim 2, wherein:
the flow reducer comprises a fustroconically shaped surface which converges the combined fluid from within the first mixing chamber into the tube.

4. A static mixing apparatus as defined in claim 2, wherein:
the second mixing chamber is located upstream within the elongated cavity relative to the plurality of baffle plates to receive the combined fluid from the second mixing chamber.

5. A static mixing apparatus as defined in claim 4, wherein:
each of the plurality of baffle plates includes curved portions;
the curved portions of the baffle plates are bent wing portions which extend at an angle relative to a portion of the baffle plate which extends transversely across the cavity;
bent wing portions of each baffle plate are adjacent to one another; and
adjacent bent wing portions are bent in opposite directions to define the openings through the baffle plates.

6. A static mixing apparatus as defined in claim 5, wherein:
all of the plurality of baffle plates occupy relative rotationally offset relationships within the elongated cavity relative to at least one of a preceding upstream or subsequent downstream baffle plate in which the openings and the bent wing portions cause the combined fluid to rotate within the elongated cavity upon flowing downstream between sequential baffle plates; and
the relative rotationally offset relationships divide the combined fluid flowing from each opening of the preceding upstream baffle plate between at least two openings of the subsequent downstream baffle plate.

7. A static mixing apparatus as defined in claim 5, further comprising:
a support plate positioned between a preceding upstream baffle plate and a subsequent downstream baffle plate, the support plate connected to the preceding and subsequent baffle plates, the support plate extending generally transversely entirely across the longitudinal cavity to a surface of the housing which defines the cavity, the connection of the baffle plates to the support plate orienting the baffle plates within the cavity, and the support plate having at least one internal opening for conducting the combined fluid through the support plate; and
a seal extending between the support plate and the surface of the housing which defines the cavity to divert any flow of combined fluid along the surface of the housing through each internal opening of the support plate.

8. A static mixing apparatus as defined in claim 7, further comprising:
a first support structure which extends between the preceding upstream baffle plate and the support plate and the flow reducer to establish the positions of the first mixing chamber, the flow reducer, the second mixing chamber, the preceding upstream baffle plate and the support plate within the elongated cavity; and
a second support structure which extends between each baffle plate and support plate to connect and orient the baffle plates and support plate within the cavity.

9. A static mixing apparatus as defined in claim 8, wherein:
the first and second support structures, the flow reducer, the plurality of baffle plates and the support plate comprise a unitary main mixing assembly;
the main mixing assembly is insertable into and removable from the cavity as a unit; and
the output portion is separable from the main mixing portion to provide access to the terminal end of the cavity for inserting the main mixing assembly into the cavity and for removing the main mixing assembly from the cavity.

10. A static mixing apparatus as defined in claim 9, further comprising:
a ring connected adjacent to the terminal end of the cavity to retain the main mixing assembly within the cavity.

11. A static mixing apparatus as defined in claim 4, wherein:
each of the plurality of baffle plates includes curved portions;
the curved portion of each baffle plate is formed as a helically spiral;
the helically spiraled baffle plates are connected together in sequence; and
the helical spiral of each subsequent baffle plate is reversed in rotational direction compared to the rotational direction of the helical spiral of the preceding baffle plate.

12. A static mixing apparatus as defined in claim 11, wherein:
the connection of each subsequent helically spiraled baffle plate to each preceding helically spiraled baffle plate positions a leading edge of the subsequent helically spiraled baffle plate perpendicular to a trailing edge of the preceding helically spiraled baffle plate.

13. A static mixing apparatus as defined in claim 4, further comprising:
a perforated plate extending transversely across the cavity at the terminal end of the cavity.

14. A static mixing apparatus as defined in claim 4, wherein:
the output portion comprises a flow reducer positioned at the terminal end of the cavity to converge the combined fluid from cavity into an outlet conduit which has a substantially smaller cross-sectional size than the cross-sectional size of the cavity.

15. A static mixing apparatus as defined in claim 14, wherein:
the flow reducer of the output portion comprises a fustroconically shaped surface which converges the combined fluid from within the cavity into the outlet conduit.

16. A static mixing apparatus as defined in claim 1, wherein:
the inlet passageway to the first mixing chamber is an orifice extending from the inlet chamber into the first mixing chamber; and further comprising:
at least one vane extending into the orifice, the vane angling relative to an axis through the orifice to rotate the flow of combined fluid from the inlet chamber when passing through the orifice.

17. A static mixing apparatus as defined in claim 1, wherein:
the inlet portion establishes a flow stream of the received carrier fluid; and
the inlet portion comprises an injector located within the inlet chamber to inject the added input fluid in a direction upstream relative to flow stream of the received carrier fluid.

18. A static mixing apparatus as defined in claim 1, wherein:
the inlet portion comprises a body which defines the inlet chamber and an inlet conduit connected to the inlet chamber, the inlet conduit and the inlet chamber each having a cross-sectional size, the cross-sectional size of the inlet chamber being substantially smaller than the cross-sectional size of the inlet chamber, the substantially larger cross-sectional size of the inlet chamber abruptly decreasing pressure and flow rate of the carrier fluid entering the inlet chamber through the inlet conduit to induce turbulence in the combined fluid within the inlet chamber.

19. A static mixing apparatus as defined in claim 1, wherein:
the inlet portion comprises a body which defines a venturi through which the carrier fluid flows to create a relative low pressure area within the venturi; and
an injection conduit connected to the body to deliver the added input fluid to the low pressure area within the venturi.

20. A static mixing apparatus as defined in claim 1, further comprising:
a perforated plate connected between the inlet portion and the main mixing portion through which the combined fluid from the inlet chamber flows when entering the main mixing portion.

21. A method of mixing a carrier fluid and an added input fluid to create an emulsified output fluid mixture, comprising:
conducting the carrier fluid and the added input fluid through a static mixing apparatus as defined in claim 1 to create the emulsified output fluid mixture.
